(19) United States
(12) Patent Application Publication
(10) Pub. No.: US 2009/0078718 A1
(43) Pub. Date: Mar. 26, 2009

(54) System and Method for Reading Inventory in a Vending Machine

(75) Inventor: Jonathan Kirschner, Powder Springs, GA (US)

Correspondence Address: SUTHERLAND ASBILL & BRENNAN LLP, 999 PEACHTREE STREET, N.E., ATLANTA, GA, 30309, US

(73) Assignee: THE COCA-COLA COMPANY, Atlanta, GA (US)

(21) Appl. No.: 11/860,890

(22) Filed: Sep. 25, 2007

(51) Int. Cl. G07F 11/16; G06F 19/00

(52) U.S. Cl. 221/2; 235/385

(57) ABSTRACT

Systems and methods of determining product information in a vending machine that includes a dispenser with a number of products having a product identifier thereon. The dispenser includes a plurality of product locations, a positioning assembly positioned about the plurality of product locations, and a reader device for reading the product identifier on one of the number of products in the plurality of product locations. The positioning assembly maneuvers the reader device about the plurality of product locations.

### TECHNICAL FIELD

This application relates to vending machines, and more particularly to systems and methods of automatically inventorying products loaded into the vending machine.

### BACKGROUND OF THE APPLICATION

Vending machines are being developed to incorporate x-y picker assemblies for picking products from a x-y product grid. The vending machines permit a vending machine operator to load the vending machine with a wide range of products. The products may be colas, fruit drinks, waters, sports drinks, and other drinks and may come in varying sizes as well as other food stuffs, other types of merchandise, and combinations thereof. Accordingly, the prices for each of these product types may vary. Typically a vending machine is programmed to identify where each product type is located in the vending machine. The vending machine operator then reloads the product types into the predetermined locations programmed into the vending machine.

However, with the increase in different product types, it may be necessary for the vending machine operator to have flexibility in determining which products to load and where to load those products in the vending machine. Further, depending upon the location of the vending machine and the season, the demand for certain drinks may vary. The vending machine operator may need the flexibility to load the vending machine in a manner to accommodate the demand. Currently, the vending machine operator would need to reprogram manually the vending machine to identify any changes in product location or product type. Given the large number of routes and vending machines managed by a vending machine operator, the reprogramming of the vending machine may be time-consuming and therefore costly. These drawbacks also may discourage the vending machine operator from reloading the vending machine to maximize sales.

Thus, there is a desire in the art for a system that gives the vending machine operator flexibility in loading of the vending machine. The vending machine operator preferably can load a vending machine with varying product types in varying locations so as to maximize potential sales and minimize loading time and burden.

### BRIEF DESCRIPTION OF THE APPLICATION

One exemplary embodiment of the present application includes a dispenser with a number of products having a product identifier thereon. The dispenser includes a plurality of product locations, a positioning assembly positioned about the plurality of product locations, and a reader device for reading the product identifier on one of the number of products in the plurality of product locations. The positioning assembly maneuvers the reader device about the plurality of product locations.

Another embodiment of the present application includes a system for determining product inventory of a x-y vending machine. The system includes a reader device attached to a x-y positioning assembly that moves the reader device across an x-y product grid of the vending machine, and a control system connected to the reader device which receives product information determined by reader device and sets the vending machine parameters based on the product information.

Yet another embodiment of the present application includes a method of inventorying a vending machine. The method includes placing a reader device on a positioning assembly of a vending machine, moving the reader device across a product grid containing a plurality of products, reading a product information on the plurality of products, and setting one or more vending machine parameters based on the product information.

### BRIEF DESCRIPTION OF THE DRAWINGS

FIG. 1 is a cross-sectional side view of a x-y vending machine according to an exemplary embodiment of the application.

FIG. 2 is a plan view of a x-y product grid and a x-y positioning assembly according to an exemplary embodiment of the application.

FIG. 3 is a perspective view of a bar code on a product according to an exemplary embodiment of the application.

FIG. 4 is a control system of the vending machine according to an exemplary embodiment of the application.

### DETAILED DESCRIPTION OF THE APPLICATION

The application now will be described more fully hereinafter with reference to the accompanying drawings, in which exemplary embodiments of the application are shown. This application may, however, be embodied in many different forms and should not be construed as limited to the embodiments set forth herein; rather, these embodiments are provided so that this disclosure will be thorough and will fully convey the scope of the application to those skilled in the art. Like numbers refer to like elements throughout the several figures.

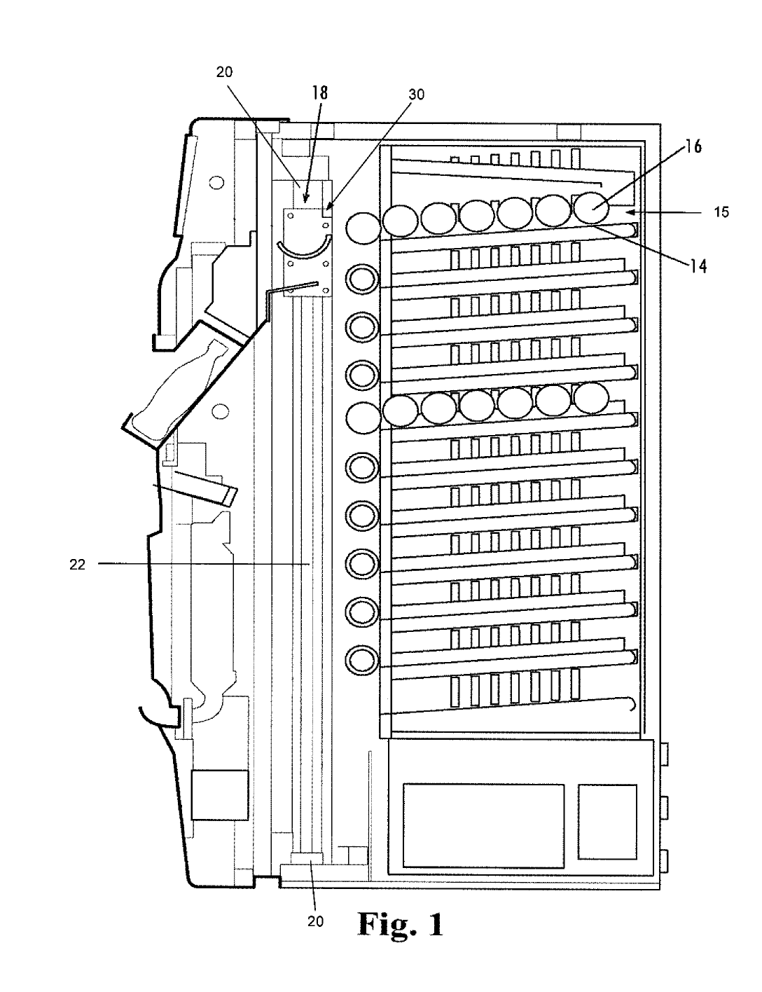

FIG. 1 is an illustrative view of a x-y vending machine 12 for use with a picker assembly 18. The x-y vending machine 12 may include a number of shelves 14 oriented in a number of rows. The shelves 14 may be configured to support a number of products 16 to be dispensed. The products 16 may be cans, bottles, boxes, or any other product desired to be dispensed. The x-y vending machine may be of conventional design. An example of an x-y vending machine suitable of use here in is shown in commonly owned U.S. Pat. No. 6,682,289 entitled _“Dispensing Apparatus and Method of Using Same”, incorporated herein by reference. Other types of vending machines as well as product dispensers and other types of enclosures may be used herein.

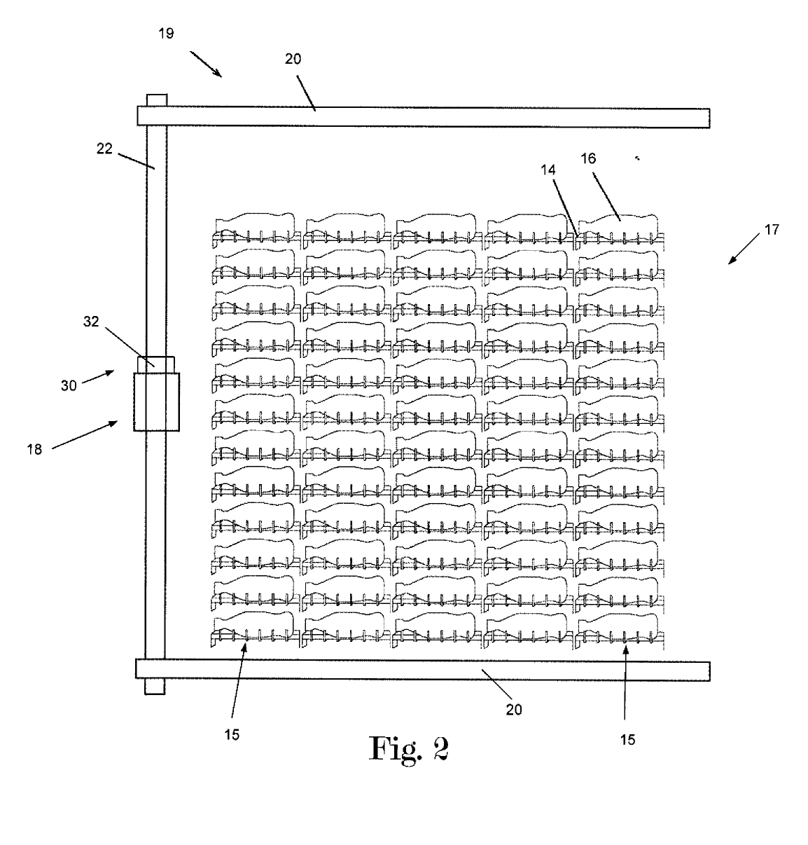

The shelves 14 may includes dividers as known in the art to provide a number of chutes 15. The products 16 may be aligned on the shelves 14 in the individual chutes. The products 16 may vary across the individual chutes 15. The combination of the rows of shelves 14 and the chutes 15 within the rows forms an x-y product grid 17 on the x-y vending machine 12 as shown in the exemplary embodiment of FIG. 2. Other configurations of the x-y vending machine 12 may be used herein.

The x-y vending machine 12 also may include a x-y positioning assembly 19 for negotiating the picker assembly 18 across the x-y product grid 17. In an exemplary embodiment, the x-y positioning assembly 19 includes a horizontal device 20 and a vertical device 22. The horizontal device 20 may include two substantially horizontal rods 21 extending across a portion of the width of the x-y vending machine 12 in a substantially parallel orientation. One of the rods 21 may be positioned substantially at the top of the x-y vending machine 12 and the second rod may be positioned substantially at the bottom of the x-y vending machine 12. The vertical device 22 may include a vertical rod 23 affixed to the horizontal device 20 such that the vertical rod 23 may move horizontally across the horizontal device 20. Other configurations of the x-y positioning assembly 19 may be used herein.

A motor assembly (not shown) may be included to move the vertical device 22 along the horizontal device 20. The picker assembly 18 may be affixed to the vertical device 22 operable to move up and down the vertical device. A motor assembly (not shown) may be included to move the picker assembly along the vertical device. Other types of motion may be used herein.

In this exemplary embodiment, the combined motion of the vertical device 22 along the horizontal device 20 and the motion of the picker assembly 18 along the vertical device 22 allows the picker assembly 18 to positioning the x-y product grid 17. A controller may be used to control the x-y positioning assembly 19 and to position the picker assembly 18 at a desired location on the x-y product grid 17.

It should be understood that the x-y positioning assembly 19 described herein is merely an exemplary embodiment. Any system capable of moving the picker assembly 18 across the x-y product grid 17 is contemplated herein, including without limitation a system of any number of vertical or horizontal devices to effect movement or a robotic arm system.

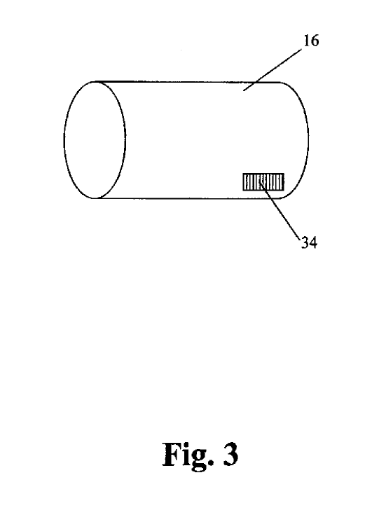

A reader system 30 for the x-y vending machine 12 may be associated with the x-y positioning assembly 19. The reader system 30 may be used to identify the inventory within the x-y vending machine 12 from a product identifier. The reader system 30 may read product information in each chute 15 of the x-y product grid 17 of the x-y vending machine 12. The reader system 30 may include a reader device 32 to read the product identifier. For example, the reader device 32 may include a bar code reader for reading bar codes 34 on the products, such as UPC numbers or SKU numbers on the products. The reading device 32 may be capable of reading any other product identifier including without limitation Snowflake code, color code, RFID tag, or other type of identifying mark positioned on the products. The example of a bar code 34 and a bar code reader device 32 will be used herein for illustrative purposes. Reading the bar code 34 on the products 16 identifies product information as to that particular product 16. For example, the bar code 34 may identify the product 16 as a plastic bottle filled with cola or it may identify the product 16 as a juice box. As illustrated in FIG. 3, bar codes 34 are customarily included on many products 16 to be used in the x-y vending machine 12 or otherwise.

The reader device 32 may be placed on or integrated into the picker assembly 18 so that it can access the x-y product grid 17 so as to obtain the individual product information for each individual chute 15. The picker assembly 18 may move across the x-y product grid 17 such that the reader device 32 may scan the bar code 34 on the first product 16 displayed on each chute 15. The first product 16 in each chute 15 may identify the contents of the entire chute 15. In another embodiment, the products 16 in each chute 15 may vary.

The reader device 32 may interface a control system 100 resident in the x-y vending machine 12. According to an exemplary embodiment of the present application, the control system 100 may include software running on a microprocessor or other suitable computing device. The control system 100 may be embodied as a method, a data processing system, or a computer program product. Accordingly, the control system 100 may take the form of an entirely hardware embodiment, an entirely software embodiment or an embodiment combining software and hardware aspects. Furthermore, the control system 100 may take the form of a computer program product on a computer-readable storage medium having computer-readable program code means embodied in the storage medium. Any suitable computer-readable storage medium may be utilized including hard disks, CD-ROMs, optical storage devices, or magnetic storage devices.

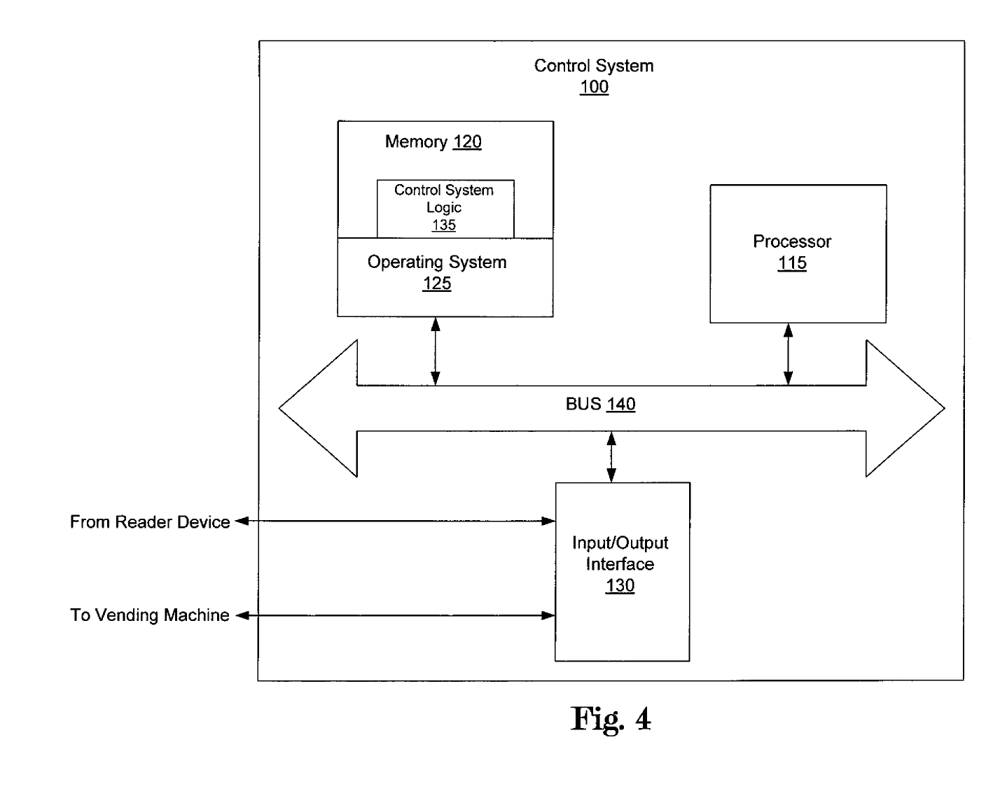

As shown in FIG. 4, the control system 100 may include a processor 115, a memory 120, an operating system 125, an input/output interface 130 and a control system logic 135, all in communication via a local interface 140. Briefly, the processor 115 may execute the operating system 125, which controls the execution of other program code such as that including the control system logic 135 for implementing the functionality described herein. The local interface 140 may be, for example but not limited to, one or more buses or other wired or wireless connections. The local interface 140 may have additional elements, which are omitted for simplicity, such as controllers, buffers (caches), drivers, repeaters, and receivers, to enable communications. Furthermore, the local interface 140 may include address, control, and/or data connections to enable appropriate communications among the aforementioned components.

The processor 115 may be a hardware device for executing software, particularly that stored on memory 120. The processor 115 may be any custom-made or commercially-available processor, a central processing unit (CPU), and auxiliary processor among several processors associated with the control system 100 a semi-conductor based microprocessor (in the form of a microchip or chip set), a macroprocessor, or generally any device for executing software instructions.

The memory 120 may includes an operating system 125 and the control system 135. The memory 120 may include any one or combination of volatile memory elements (e.g., random access memory (RAM), such as DRAM, SRAM, SDRAM, etc.) and non-volatile memory elements (e.g., ROM, hard drive, tape, CD-ROM, etc.). The memory 120 may incorporate electronic, magnetic, optical and/or other types of storage media. Furthermore, memory 120 may have a distributed architecture, in which various components are situated remote from one another, but can be accessed by processor 115.

The software in memory 120 may include one or more separate programs, each of which comprising executable instructions for implementing logical functions. In the example of FIG. 4, a software in memory 120 includes the control system logic 135 according to the present invention. The memory 120 may further comprise a suitable operating system 125 that controls the execution of other computer programs, such as the control system logic 135, and provides scheduling, in-output control file and data management, memory management, and communication control and related services.

The input/output interfaces 130 may be any device or devices configured to facilitate communication with the control system 100. The communications can be with a communication network, such as a public or private packet-switched or other data network including the Internet, a circuit switched network, such as the public switch telephone network, a wireless network, an optical network, or any other desired communication infrastructure. Alternatively, the input/output interfaces may also include any one of the following or other devices for facilitating communication with local interface 140: a user interface device such as a keyboard or mouse, a display device such as a computer monitor, a serial port, a parallel port, a printer, etc. During operation of the control system 100, a user may interact with the control system logic 135 via such user interface and display devices.

The control system logic 135 may be a source program, executable program (object code), script, or any other entity comprising a set of instructions to be performed. When implemented as a source program, then the program needs to be translated via a compiler, assembler, interpreter, or like, which may or not be included within the memory 120, so as to operate properly in connection with the operating system 125. Furthermore, the control system logic 135 may be written as an object oriented program language, which has classes of data and methods, or a procedure program language, which has routines, sub-routines, and/or functions, for example but not limited to, C++, Pascal, Basic, Fortran, Cobol, Perl, Java, and Ada.

In an exemplary embodiment, the control system 100 is located within the x-y vending machine. However, it will be appreciated by one of ordinary skill in the art that one or more of the control system 100 components may be located geographically remotely from other control system 100 components. Furthermore, one or more of the components may be combined, and additional components performing functions described herein may be included in the control system 100.

The control system 100 is configured to receive through the input/output interface 130 information received from the reader device 32 and output instructions to the vending machine based on the information received from the reader device 32. The control system 100 through the control system logic 135 may control the operation of the x-y vending machine 12, and may include determination of sales information, cost of products, and returning change to the consumers.

The reader device 32 may transmit the product information for each chute 15 to the control system 100. Based on the product information, the control system 100 may set vending machine parameters, such as the appropriate price information, for each chute 15. The control system 100 also may store other product inventory information such as product placement, quantity of products sold, and other information based on the loading of the products 16 into the x-y vending machine 12. The information stored in the control system 100 may be transmitted to a handheld device of the vending machine operator or transmitted over a network to a central processing facility. The information may be used for marketing, sales, distribution, product placement, or any other appropriate purpose.

The reader system 30 permits the vending machine operator to easily load the x-y vending machine 12 with new products 16 without having to reprogram the control system 100. The vending machine operator does not need to waste time or resources loading products 16 into predetermined chutes 15. The chutes 15 may be loaded with any product 16 and the reader system 30 may determine the product information for that chute 15. The reader system 30 gives the vending machine operator the opportunity to easily change the products 16 in any given chute 15 based on lack of sales, inventory, or any other reason by loading the chute 15 with a new product 16.

For example, if fruit drinks are not selling well in a given location but cola is selling well, the vending machine operator may remove the fruit drinks from a chute 15 and load cola into the chute 15 previously containing the fruit drinks. Upon completion of loading the x-y product grid 17 with products 16, the vending machine operator may then calibrate the x-y vending machine 12 by instructing the picker assembly 18 to carry the reader device 32 across the x-y product grid 17 to read the bar codes 34 of each individual chute 15. The reader device 32 may be carried to read the products 16 in any order, including row-by-row or column-by-column. In this example, the reader device 32 would then determine that a new product 16 is a 12 ounce cola and report that information to the control system. The control system 100 may then set the proper pricing information for that given chute 15 and the other chutes 15 loaded with products 16.

The reader system 30 also may be portable. As known in the art, many vending machine operators use handheld devices that interface with existing control systems on vending machines. The handheld devices may download sales and other information from the x-y vending machine 12. Therefore, the reader device 32 may be integrated into a handheld device to be used by the vending machine operator. The vending machine operator may simply place the handheld device incorporating the reader device 32 onto the picker assembly 18 to initiate the reading of the inventory of the x-y vending machine 12. The exemplary embodiment of incorporating the reader device 32 into handheld devices has the advantage of reducing cost and expense. Only one reader device 32 may be needed per vending machine operator. The vending machine operator could use the reader device 32 on any number of vending machines or other devices on his route.

Many modifications and other embodiments of the application will come to mind to one skilled in the art to which this application pertains having the benefit of the teachings presented in the foregoing descriptions and the associated drawings. Therefore, it is to be understood that the application is not to be limited to the specific embodiments disclosed and that modifications and other embodiments are intended to be included within the scope of the appended claims. Although specific terms are employed herein, they are used in generic and descriptive sense only and not for purposes of limitation.

1. A dispenser with a number of products having a product identifier thereon, comprising:
a plurality of product locations;
a positioning assembly positioned about the plurality of product locations; and
a reader device for reading the product identifier on one of the number of products in the plurality of product locations;
wherein the positioning assembly maneuvers the reader device about the plurality of product locations.

2. The system of claim 1, wherein the reader device comprises a bar code reader.

3. The system of claim 1, wherein the product identifier comprises a bar code.

4. The system of claim 1, wherein the product identifier comprises the type and size of the product.

5. A system for determining product information in a x-y vending machine, comprising:
a reader device attached to a x-y positioning assembly that moves the reader device across an x-y product grid of the vending machine;
a control system connected to the reader device which receives product information determined by reader device and sets the vending machine parameters based on the product information.

6. The system of claim 5, wherein the reader device is transportable.

7. The system of claim 5, wherein the reader device comprises a bar code reader or snowflake reader.

8. The system of claim 5, wherein the x-y product grid comprises at least one product comprising at least one code.

9. The system of claim 5, wherein the product information comprises the type and size of the product.

10. The system of claim 5, wherein the vending machine parameter comprises price information.

11. The system of claim 5, wherein the control system comprises a wireless router to wirelessly receive the product information from the reader device.

12. The system of claim 5, wherein the control system is connected to the reader device through a hard-wired cable.

13. A method of inventorying a vending machine, comprising:
placing a reader device on a positioning assembly of a vending machine;
moving the reader device across a product grid containing a plurality of products;
reading a product information on the plurality of products; and
setting one or more vending machine parameters based on the product information.

14. The method of claim 13, wherein the reader device comprises a bar code reader or snowflake reader.

15. The method of claim 13, wherein the product may comprise a code comprising product information.

16. The method of claim 13, wherein the reader device is placed on a picker assembly.

17. The method of claim 13, wherein the product information comprises a product model.

18. The method of claim 13, wherein the vending machine parameters comprises price of the product.

19. The method of claim 13, wherein the product information is communicated to the control system through a cable.

20. The method of claim 13, wherein the product information is communicated to the control system wirelessly.
